(19) United States
(12) Patent Application Publication
(10) Pub. No.: US 2018/0338884 A1
(43) Pub. Date: Nov. 29, 2018

(54) Soft Tissue Mobilization Instrument Utilizing Thumb Cup

(71) Applicant: Carl R. Hanson, Medford, OR (US)

(72) Inventor: Carl R. Hanson, Medford, OR (US)

(21) Appl. No.: 15/603,348

(22) Filed: May 23, 2017

(51) Int. Cl. A61H 7/00; A61H 1/00

(52) U.S. Cl. CPC A61H 7/003; A61H 2201/1638; A61H 2201/1253; A61H 1/008

(57) ABSTRACT

A soft tissue mobilization instrument for use in the treatment of the soft tissue of a person being treated by a practitioner having a handle structured for grasping by the hand of the practitioner, an offset body engaging, elongated, elliptical shaped thumb cup working member, and an index finger guide connecting the handle and the working member structured to locate and support the outer edge of the index finger of the practitioner when grasping the instrument. The instrument allows treatment pressure to come from the practitioner's hand thereby relieving pressure on the thumb during a treatment process.

### BACKGROUND OF THE INVENTION

The present invention relates to a hand held, soft tissue manipulation instrument.

Typically, a practitioner of body work such as deep tissue massage, chiropractic, rehabilitation therapy and the like use the hands as a primary tool to access soft tissue restrictions and degeneration. This work applies significant pressure on the various joints of the thumb and fingers often resulting in physical degradation of the practitioner's hands and subsequently limiting the ability to efficiently perform the necessary work and ultimately shortening the practitioner's career. The use of tools to assist practitioners in the various arts of body work is well known and has been used for many years. These tools or instruments are commonly known as STM or soft tissue mobilization tools. The tools are used to assist the practitioner to apply pressure to injured areas such as muscles, tendons and ligaments which are difficult to soften or treat with the hands only. Typically, a STM tool allows the practitioner to move over an injured area and apply pressure. This, in turn, facilitates loosening and softening or mobilization of the injured tissue to increase blood flow into the injured area promoting healing.

The thumb is the most sensitive and significant as well as being the strongest of the digits of the hand used in this type of body work healing process.

However, because of constant use, many practitioners have found their careers shortened because the joints of the thumb are degraded as they are used to heal, often becoming arthritic and painful to use. This is a common occurrence, particularly among women, since they typically are smaller in size and lack the strength of men yet have the same professional requirements and are required to do essentially the same healing protocols as men resulting in increasing stress on the hands and thumbs in particular.

### SUMMARY OF THE INVENTION

The instrument of the present invention typically eliminates the above described problems. It allows a practitioner to apply the needed pressure to an injured area of a person being treated without creating excessive forces that typically are absorbed by the thumb and fingers. In addition, the instrument is easy to hold and manipulate using the whole hand while providing sufficient sensory feedback that can be used to regulate the forces and location where they are applied on the body of the person receiving treatment.

The hand-held instrument of the present invention eases pressure on a practitioner's thumb during use by transferring pressure from the carpometacarpal CMC and metacarpophalangeal MCP joints to the palm and finger portions of the hand while simultaneously allowing the practitioner to use the thumb for sensory feedback and guidance while working on an injured area of the body of a person being treated. This reduces stress and wear of the thumb joints helping to prolong the practitioner's career.

The instrument includes a handle, an elongated, elliptical shaped body engaging number that forms a thumb cup for the practitioner's thumb and an index finger guide that is an integral part of the instrument and connects the handle and the thumb cup body engaging member. The thumb cup has a generally elongated, elliptical shape having a convex outer surface that is used to apply pressure against the body of the person being treated and a concave, cup shaped, inner surface designed and structured to receive a practitioner's thumb when using the instrument for the treatment of soft tissue. The index finger guide between the body engaging member and the handle serves as a locator and support for the outer area of the index finger of the practitioner's hand when the practitioner is working on the soft tissue of a person being treated. The shaped, thumb cup body engaging member takes the place of the practitioner's thumb to break up adhesions and other physical degradation of the soft tissue.

The instrument allows the practitioner to exert a downward pressure in the same manner as when using the thumb but substitutes the stronger, entire hand grasping the handle area of the instrument, to provide the necessary pressure needed to treat the injured areas. Thus, when the practitioner grasps the instrument with the fingers and palm of the hand, the outside of the index finger sits against the index finger guide while the remaining fingers and palm of the hand holds the handle. In this position as the index finger rest against and is supported by the index finger guide, the index finger also engages and supports the thumb providing additional support practically eliminating any stress against the thumb when pressure is applied during a treatment session. The thumb fits into the concave area of the thumb cup shaped body engaging member allowing the thumb to guide the placement and movement of the instrument as it is used in a healing protocol and also provides sensory feedback to determine the proper pressure to be applied to an injured area.

The instrument allows the practitioner to apply pressure in several different ways since the instrument can be placed at a variety of different angles with the integrity of the grip of the instrument being maintained by the index finger guide that prevents any excessive movement of the hand during treatment.

The instrument allows sufficient pressure to be applied to the body engaging member and, in turn, to the individual being treated, from the hand without requiring any significant pressure from the thumb.

Among the objects of the invention is the provision of a body treatment instrument that eliminates stress on a practitioner's fingers and thumb when using the instrument to perform body work on an individual.

Another object is the provision of a body work instrument that fits the hand of one using it allowing ease in moving and manipulating the instrument during use.

These and other objects will be apparent from the following written specification and accompanying drawings.

### DESCRIPTION OF THE DRAWINGS

FIG. 1 is a perspective view of the instrument of the present invention.

FIG. 2 is a front elevational view of the instrument of FIG. 1.

FIG. 3 is a rear elevational view of the instrument.

FIG. 4 is a left side elevational view of the instrument.

FIG. 5 is a right side elevational view of the instrument.

FIG. 6 is a top end view of the instrument.

FIG. 7 is a bottom end view of the instrument.

FIG. 8 is a view of the instrument being held by a hand of the practitioner using the instrument.

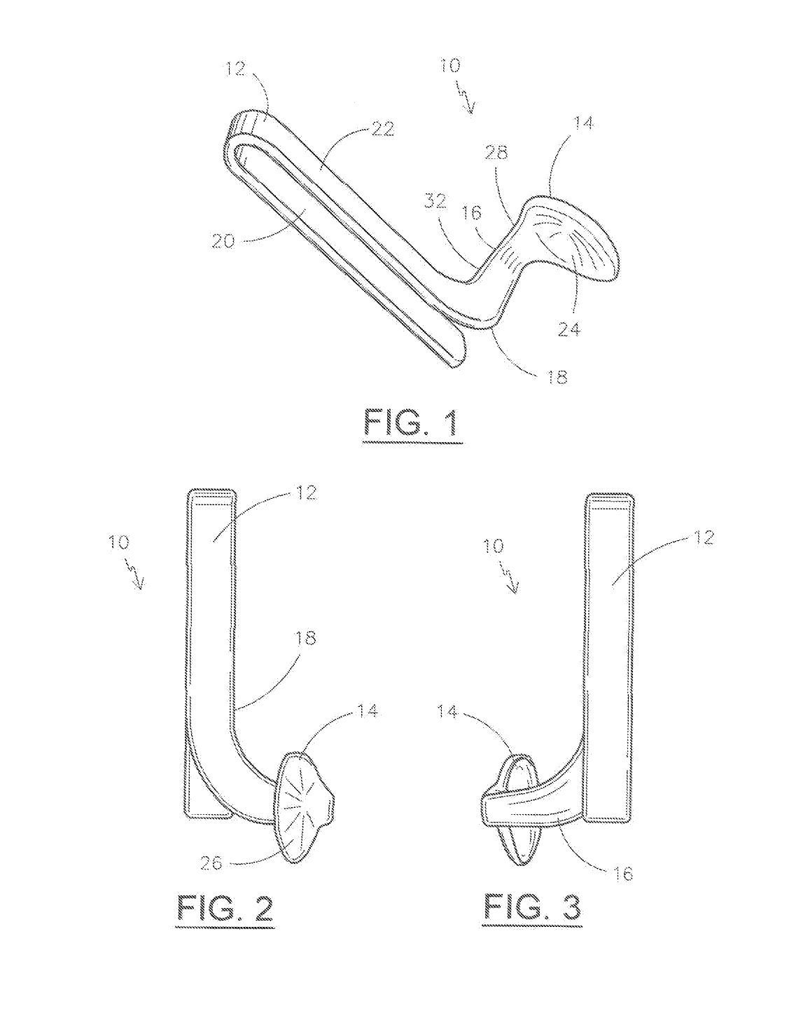

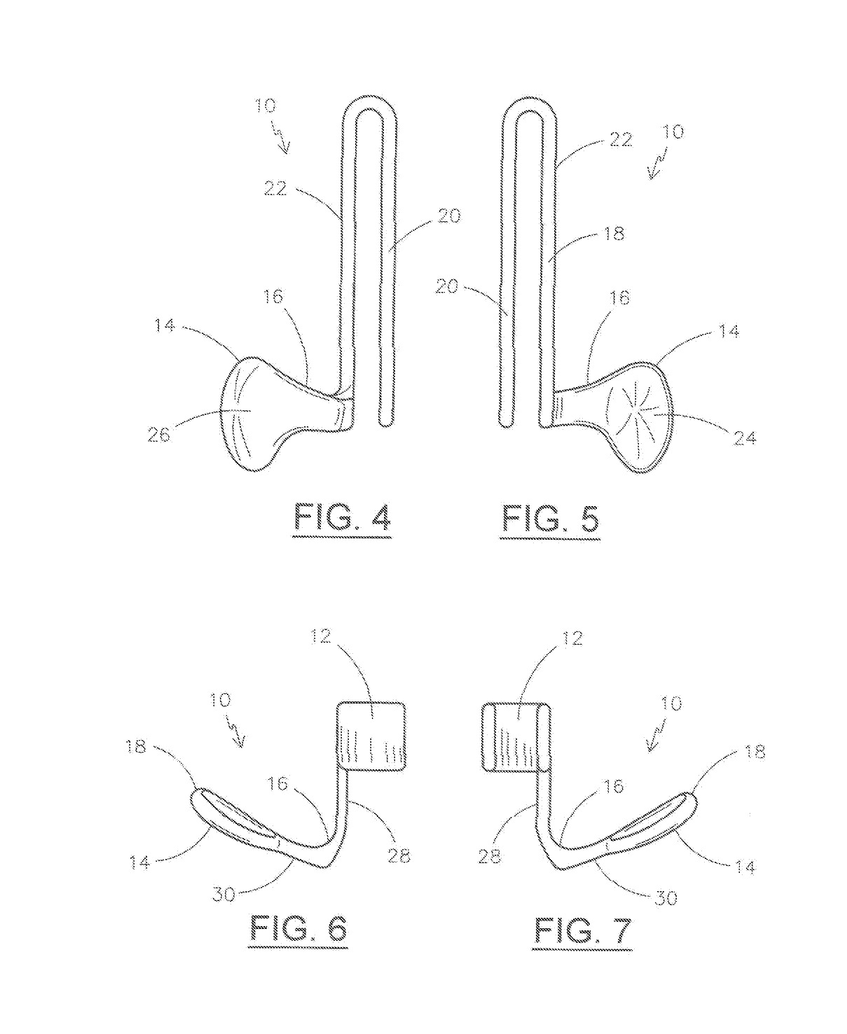

### DESCRIPTION OF PREFERRED EMBODIMENTS

Referring to the drawings the hand held, soft tissue mobilization instrument 10 of the present invention is formed in three parts, a handle 12, on elongated elliptical, shaped thumb cup, body engaging, working member 14 and an index finger guide 16 that extends between and connects the handle 12 to the thumb cup shaped, working member 14. In the preferred embodiment, the instrument 10 is made of polished stainless steel with rounded edges 18 for ease in handling and reducing the chance of accidental injury to either the person being treated or the practitioner using the instrument 10.

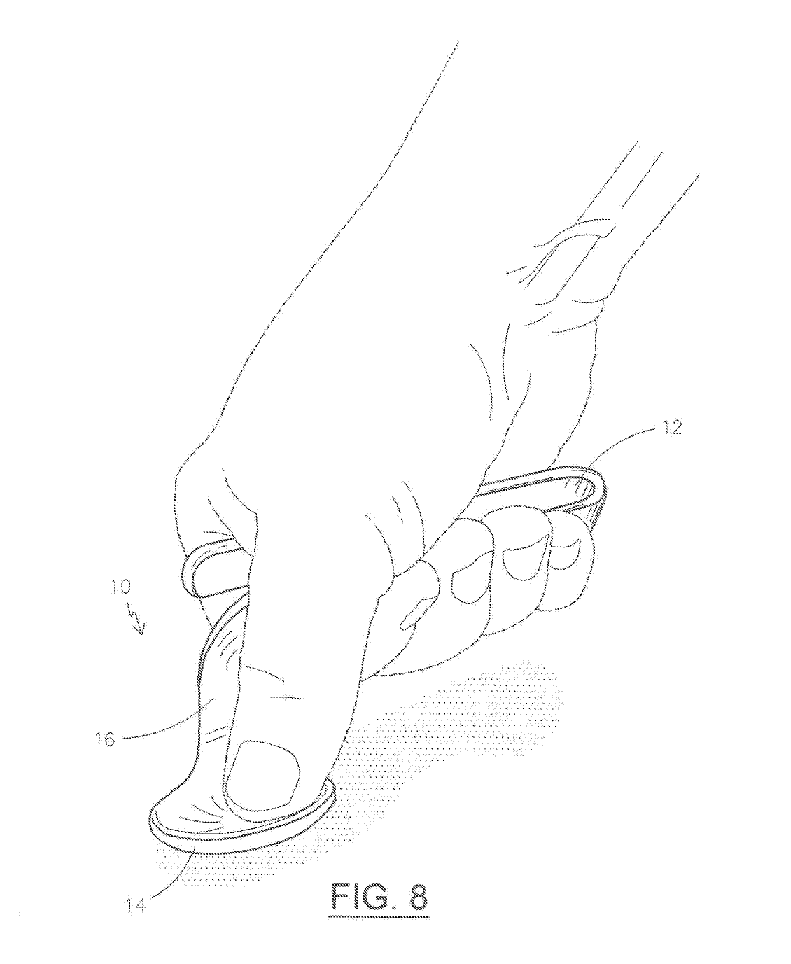

The handle is made of complimentary, overlapping sections 20 and 22 of stainless steel and sized to enable the hand of the user to comfortably hold and manipulate the instrument. The thumb cup, working member 14 is shaped with an inner curved, concave surface 24 to locate and support the thumb of the practitioner during use and an outer convex surface 26 that contacts and applies pressure to the various body areas of an individual being treated. The index finger guide 16 is formed integral with both the handle 12 and the working member 14 and is part of a single elongated stainless steel stock. The index finger guide 16 is integrally connected to the handle 12 at approximately an angle of 90 degrees and extends outwardly perpendicular to the longitudinal axis of the handle 12. The connector 15 attaches to the side of the working member 14 whereby the longitudinal axis of the elongated, elliptical working member 14 is essentially parallel to the longitudinal axis of the handle 12 and generally perpendicular to the longitudinal axis of the elongated elliptical, shaped body engaging, working member 14. With this structure, the working member 14 is slightly offset laterally approximately an average thumb's width as well as being located below the handle 12. The index finger guide 16 is formed in two sections, a first handle section 28 and a second working member section 30 that is disposed at approximately 60 degrees to the handle section 28 such that the thumb cup working member 14 is also at an angle of 60 degrees with respect to the handle 12. An inner edge 32 of the index finger guide 16 serves as a support for the outer edge of the index finger of the practitioner and enables the index finger to support the thumb relieving pressure on the thumb as a soft tissue procedure is conducted. The finger index guide 16 also provides a bearing surface against which pressure may be applied allowing the hand to control and manipulate the working member 14 of the instrument 10 while the thumb serves as a guide and does not create pressure on the working member 14. See FIG. 8 that discloses the orientation of a practitioner's hand holding the instrument 10.

A preferred instrument 10 is approximate 4-5 inches measured along the length of the handle 12. The thumb cup shaped working member 14 has an elongated, elliptical shape approximately 1.5 inches long and 1.0 inches wide, although it will be appreciated the working member 14 may be more rounded and be just as effective for the purposes described. The index finger guide 16 handle section 28 is approximately 1.0 inches and the working member section 30 of the index finger guide 16 is approximately 0.5 inches. These sections are disposed at an angle of 60 degrees creating an offset of the working member 14 relative to the handle 12.

In use, a practitioner grasps the handle 12 of the instrument 10 and places the convex side 24 of the thumb cup working member 14 against an area on a person to be treated while having the ball of the thumb on the inner concave surface 26 of the working member 14. In this position, the outer edge of the index finger of the hand rests against the inner edge 28 of the index finger guide 16. This placement and location of the practitioner's hand on the instrument 10 creates the pressure on the working member 14 through the handle 12 and index finger guide 16 directly from the entire hand rather than from just the thumb of the practitioner.

It will be appreciated that the instrument may be made of separate parts and/or of different material. For example, the handle may be cylindrical or have another hand conforming shape. Likewise, the connector and working member can be made of separate pieces as long as they are connected and arranged to allow the working member to accommodate the thumb of the practitioner as described above. Other modifications are possible in keeping within the scope and limits of the following claims.

1. A soft tissue mobilization instrument for use in the treatment of the soft tissue of a person being treated by a practitioner comprising:
a handle structured for grasping by the hand of the practitioner;
a body engaging working member;
and, an index finger guide connecting said handle and said working member structured to locate and support the outer edge of the index finger of the practitioner when grasping the instrument.

2. The instrument of claim 1 wherein said index finger guide is disposed approximately perpendicular to a longitudinal axis of said handle.

3. The instrument of claim 2 wherein said index finger guide is disposed approximately perpendicular to a longitudinal axis of said working member.

4. The instrument of claim 1 wherein said index finger guide is formed in two sections; a first handle section and a second working member section; said first handle section of said index finger guide being connected perpendicular to said handle and said second working member section of said index finger guide connected to said working member.

5. The instrument of claim 4 wherein said first section and said second working member section of said index finger guide are disposed at an angle of approximately 60 degrees to each other.

6. The instrument of claim 5 wherein said working member is offset from and disposed at an angle of approximately 60 degrees to said handle.

7. The instrument of claim 1 being further defined by said working member having smooth, rounded peripheral edges.

8. The instrument of claim 1 being further defined as being stainless steel.

9. The instrument of claim 1 wherein said working member is formed in an elongated, elliptical configuration with a longitudinal axis that is parallel to a longitudinal axis of said handle.

10. A soft tissue mobilization instrument for use in the treatment of the soft tissue of a person being treated by a practitioner comprising:
an elongated handle structured for grasping by the hand of the practitioner;
a body engaging working member; said working member being cup shaped with an inner curved, concave surface to locate and support the thumb of the practitioner during use and an outer convex surface that contacts and applies pressure to the various body areas of an individual being treated;
and, an index finger guide connecting said handle and said working member structured to locate and support the outer edge of the index finger of the practitioner when grasping said cup shaped working member; said index finger guide is disposed approximately perpendicular to a longitudinal axis of said elongated handle and disposed approximately perpendicular to a longitudinal axis of said working member.

11. The instrument of claim 10 wherein said index finger guide is formed in two sections; a first handle section of said index finger guide connected perpendicular to said handle and a second working member section of said index finger guide connected to said working member.

12. The instrument of claim 11 wherein said first section and said second working member section of said index finger guide are disposed at an angle of approximately 60 degrees to each other.

13. The instrument of claim 12 wherein said working member is offset from and disposed at an angle of approximately 60 degrees to said handle.

14. The instrument of claim 10 wherein said working member is formed in an elongated elliptical configuration with a longitudinal axis that is parallel to a longitudinal axis of said elongated handle.

15. A soft tissue mobilization instrument for use in the treatment of the soft tissue of a person being treated by a practitioner comprising:
an elongated handle structured for grasping by the hand of the practitioner;
a body engaging, working member; said working member being cup shaped with an inner curved, concave surface to locate and support the thumb of the practitioner during use and an outer convex surface to contact and apply pressure to the various body areas of an individual being treated; said working member being formed in an elongated, elliptical configuration with a longitudinal axis that is parallel to a longitudinal axis of said elongated handle.
and, an index finger guide connecting said handle and said working member structured to locate and support the outer edge of the index finger of the practitioner when grasping said cup shaped working member; said index finger guide being disposed approximately perpendicular to a longitudinal axis of said handle and disposed approximately perpendicular to a longitudinal axis of said working member; said index finger guide further defined by being formed in two sections, a first handle section and a second working member section; said first handle section of said index finger guide connected perpendicular to said handle and said second working member section of said index finger guide connected to said working member; said first handle section and said second working member section of said index finger guide being further defined as disposed at an angle of approximately 60 degrees to each other; said cup shaped working member being offset from and disposed at an angle of approximately 60 degrees to said handle.
